(19) United States
(12) Patent Application Publication
(10) Pub. No.: US 2004/0229065 A1
(43) Pub. Date: Nov. 18, 2004

(54) High refractive index coated embossable film

(75) Inventors: Wolfgang Decker, Wakefield, RI (US); Shawn Early, Coventry, RI (US); Jaimy Mauricio, Newport, RI (US); Christopher S. Curry, Exeter, RI (US)

Correspondence Address: Jonathan Bockman, Morrison & Foerster LLP, Suite 300, 1650 Tysons Blvd, McLean, VA, 22102, US

(73) Assignee: Toray Plastics (America), Inc., North Kingstown, RI

(21) Appl. No.: 10/788,416

(22) Filed: Mar. 1, 2004

Related U.S. Application Data
(60) Provisional application No. 60/450,329, filed on Feb. 28, 2003.

(51) Int. Cl. B32B 27/08

(52) U.S. Cl. 428/515; 428/500; 427/357

(57) ABSTRACT

An embossable film for creating holograms and diffraction gratings and methods of producing the embossable films are provided. The embossable film is coated with a transparent high refractive index (HRI) coating prior to embossing.

### FIELD OF INVENTION

This invention relates to embossable films for creating holograms and diffraction gratings. More specifically, this invention relates to an embossable film that is coated with a transparent high refractive index (HRI) coating prior to embossing.

### BACKGROUND

Holograms have come into wide usage as decorative indicia due to their unique visual appearance. In addition, the difficulty in making and reproducing holograms has made them a common authentication feature on security items such as credit cards, driver's licenses and access (identification) cards. Holograms have also been used as security features on products in order to prevent piracy or counterfeiting.

The most common method of creating a hologram is to create a grating pattern in a surface so that particular structures become visible upon diffraction of light in the grating. U.S. Pat. No. 3,578,845 to Brooks et al. describes how diffraction gratings are typically generated. Typically, the diffraction patterns are embossed into a thermo-formable substrate such as an embossable polymer film. This process is performed by pressing a heated stamp made from a hard material to engrave the desired grating from the contact surface of the stamp onto the embossable substrate.

Diffraction requires that the medium the grating is made of and the media bordering the grating have a difference in optical index. The larger this difference is, the brighter the diffraction will appear. To create highest diffraction, full reflective materials such as aluminum, copper or gold are thin film coated onto the surface of the grating.

Alternately, the grating is coated with a thin film of transparent material having a high refractive index (HRI) such as Zinc Sulfide (ZnS), Iron Oxide (Fe₂O₃), Lead Oxide (PbO), Zinc Selenide (ZnSe), Cadmium Sulfide (CdS), Titanium Oxide (TiO₂), Lead Chloride (PbCl₂), Cerium Oxide (CeO₂), Tantalum Oxide (Ta₂O₅), Zinc Oxide (ZnO), Cadmium Oxide (CdO) or Neodymium Oxide (Nd₂O₃). Substrates coated with a transparent HRI coating are often used for security applications such as identification or access cards, where it is desired that information positioned behind the hologram remains visible to the unaided eye.

While the grating can be embossed into the substrate material with a stamp, a more common, economical method, is the use of continuous embossing systems. Such embossing system are described for example in U.S. Pat. Nos. 4,913,858 and 5,164,227, both to Miekka et al. In these methods the grating structure is engraved into the surface of a roll, which continuously presses its surface pattern into the web type substrate passing between the embossing roll and a backside roll. In order to obtain the grating in the substrate's surface, the thermo-formable layer on this surface is heated. This can be achieved either by preheating the substrate to the required temperature, or by heating the embossing roll.

Commonly the art differentiates between “Soft Embossing” and “Hard Embossing”. Soft Embossing describes the process where the embossing is performed before a reflection enhancement layer is applied. “Hard Embossing” is performed by creating the grating through the reflection enhancement layer. While Hard Embossing is done on substrates coated with “soft” metals like aluminum, copper or gold, it is not typically done through semi-transparent reflection enhancement layers like ZnS or TiO₂. Semi-transparent layers are coated thicker than metal coatings in order to achieve the brilliance and reflectivity typically desired. The typical coating thickness for ZnS for example is about 400-600 Angstroms (40-60 nm), while aluminum is typically coated with about 200 Angstroms or less. In addition, semi-transparent coatings are much harder than metal coatings. ZnS has a Mohs hardness of 4.5 Mohs, compared to a Mohs hardness of 2.75 for aluminum. These two factors would require higher embossing pressure on standard substrates and increase the wear on the embossing shims.

A common process for producing an embossable web type substrate such as an embossable polyethyleneterephthalate (PET) or polypropylene (PP) is to apply a thermo-formable coating onto at least one surface of the polymer film. This process is done off-line, i.e. after manufacturing of the polymer web. Embossable coatings typically are applied either as a water-based or as a solvent-based solution using coating systems well known in the art such as roll coating, gravure coating, air knife coating or rod coating, among others.

The coatings are dried in hot oven systems, designed to drive out the moisture and solvents and to lock the coating into a coherent structure. It is common, though, that an excessive amount of moisture or solvent is retained in the coating. HRI coatings, however, are typically applied using vacuum deposition processes such as physical vapor deposition. The exposure of the embossable coatings to a vacuum causes the remaining moisture or solvent to evaporate, a process called “outgassing”. Outgassing is an unwanted reaction as it hinders the deposition of the HRI coating, causing uneven deposition of the HRI material and rendering the material useless for commercial application. Embossing done prior to vacuum coating exposes the coating to additional heat and pressure of the embossing process, improving the removal of entrapped moisture and solvents. This is an additional reason why the transparent HRI coating is typically not done until after application of the embossing.

As is described in U.S. patent application Ser. No. 10/087,689, filed Mar. 1, 2002, and Ser. No. 10/206,453, filed Jul. 26, 2002, the both of which hereby are incorporated in their entirety by reference, it would be desirable to provide an embossable film structure that is made at the point of film manufacturing. As is pointed out, however, embossable surfaces produced through a co-extrusion process need to have many of the same characteristics of the base film. Therefore, inherent viscosity (IV), melt strength, melt viscosity and the like are important parameters for getting the co-extruded layer through the film making process.

Typical materials that can survive this process are often analogs of the base film material itself. These materials suffer the problem of having low crystallinity and are, therefore, heat sealable. A heat sealable material will often stick to the embossing shim, rendering the embossed texture of little commercial quality. Such a co-extruded layer, however, would also be free of moisture or solvent, thus eliminating the above described problems of outgassing.

In addition, it would be desirable to have an embossable multi-layer film that is coated with a transparent HRI coating that can be embossed through the HRI coating, directly accepting holographic texture and presenting a good image after lamination. Such a material would offer higher flexibility for the production of semi-transparent holograms. The nature of the HRI coating process requires that specific minimum lengths have to be coated. This length requirement is not given if HRI coating is applied prior to embossing. Such a material would allow for shorter, volume limited production of specific holograms. Especially in the area of high security holograms it would reduce the high risk requirement of moving high security holograms between facilities.

### SUMMARY OF THE INVENTION

Described are embossable films and methods for making embossable films for creating holograms and diffraction gratings. The embossable films are coated with a transparent high refractive index (HRI) coating.

In one embodiment, the embossable film includes a base layer, an embossable layer on a surface of the base layer and a high reflective index layer on a surface of the embossable surface. This embossable film is directly embossable.

Preferably, base layer includes polyethyleneterephthalate (PET). Preferably, the embossable layer includes a non-crosslinked polystyrene-acrylic or a non-crosslinked polyester. Preferably, the embossable layer includes a resin having a Tg of greater than 20° C. and less than 70° C. Preferably, the base layer has a thickness of 4.5 μm to 150 μm, the embossable layer has a thickness of 0.1 μm to 2.0 μm, and the transparent high reflective index layer has a thickness of 50 Angstroms to 1500 Angstroms.

Preferably, the transparent high reflective index layer includes ZnS, Sb₂S₃, Fe₂O₃, PbO, ZnSe, CdS, TiO₂, PbCl₂, CeO₂, Ta₂O₅, ZnO, CdO or Nd₂O₃ and is applied using a physical vapor deposition process.

Another embodiment of the invention is a method of producing a diffraction grating. The method includes providing a substrate film with an embossable layer, applying a transparent high reflective index layer on top of the embossable layer and embossing the film to create a diffraction grating image.

Yet another embodiment is a method of producing a directly embossable film. The method includes providing a polyethyleneterephtalate film, stretching the polyethyleneterephthalate film to form a uniaxially oriented polyethyleneterephthalate film, coating at least one surface of the uniaxially oriented polyethyleneterephthalate film with an aqueous solution of an organic material to form an embossable layer, transverse stretching the coated uniaxially oriented polyethyleneterephthalate film and applying a transparent high reflective index coating to embossable layer of the polyethyleneterephthalate film to form a directly embossable film.

### BRIEF DESCRIPTION OF THE DRAWINGS

The invention will be better understood by reference to the Detailed Description of the Invention when taken together with the attached drawings, wherein:

FIG. 1 is an apparatus for preparing applying a transparent HRI coating to a film substrate containing an embossable layer according to the invention;

FIG. 2 is an embossable transparent HRI coated film according to the invention; and

FIG. 3 is a schematic representation of a continuous embossing system used to impose the diffractive grating onto an embossable substrate in accordance with the invention.

### DETAILED DESCRIPTION OF THE INVENTION

The invention includes a semi-transparent embossable multi-layer film that has a transparent HRI coating and methods of making this film. The embossable multi-layer film can be embossed and is ready for lamination without the need for a subsequent transparent HRI coating step or a subsequent embossable coating step.

It has been found that a High Refractive Index (HRI) coating can be deposited on top of an in-line coated directly embossable film to produce a semi-transparent embossable multi-layer film that is embossable through the HRI coating and exhibits excellent light diffraction.

This in-line coated film offers several advantages for embossing when “hard embossing” of HRI coated material is desired. Embossing temperatures for this film tend to be lower when compared to those used in making off-line coated embossable coatings. The in-line coated layers appear to be softer during the embossing process compared to off-line coated embossable layers without the HRI coating.

The higher softness or reduced viscosity of the in-line coated film allows the transfer of the surface structure from the embossing shim into the substrate surface through the HRI coating with similar heat and pressure as embossing into off-line coated substrates without HRI coating. This means that additional stress on the embossing shim is minimized. Accordingly, this process yields a comparable lifetime for the shim when compared to embossing off-line coated substrates without HRI coatings.

Preferably, the semi-transparent embossable multi-layer film includes a base substrate film, an embossable layer and a transparent HRI coating.

Preferably, the base substrate is a polyethyleneterephthalate (PET) film that is produced by extrusion. A preferred process for producing the base substrate and embossable layer is described in U.S. patent application Ser. No. 10/087,689, which was published in the U.S. as Publication No. US 2003-0077467 A1, on Apr. 24, 2003, and Ser. No. 10/206,453, which was published in the U.S. as Publication No. US 2003-0108756 A1, on Jun. 12, 2003.

The base substrate and embossable layer can be produced by inline coating a uniaxially oriented PET film, drying and then transverse stretching the film to produce a composite structure of PET and a coating which forms the embossable layer.

The PET base substrate preferably has a Tg of greater than about 35° C., but less than about 70° C. The PET film preferably has a thickness of about 4.5 A1,m to about 150 μm more preferably, between 7 μm and 60 μm. Preferably, the PET contains particles. Preferred particles include silica, alumina, calcium carbonate and mixtures thereof, although other types of particles are possible. The particles are also preferably present in the amount of about 0.05 wt % to about 0.6 wt %, based on the weight of the PET film.

A preferred embossable coating is an aqueous solution. Preferably, the coating includes an organic material. Preferred organic materials include a non-crosslinked polystyrene-acrylic emulsion or a non-crosslinked polyester dispersion. Preferably, the coating resin has a Tg of greater than about 20° C. More preferably, the coating has a Tg of greater than about 35° C. and less than about 70° C. Preferably, the coating is capable of impregnating the PET surface on drawing, thereby rendering the film surface susceptible to embossing under pressure such that the coating has a low heat sealability.

Preferably, the thickness of coating, that forms the embossable layer, is between about 0.1 μm and about 2.0 μm, more preferably between about 0.1 μm and about 0.8 μm, most preferable between about 0.1 μm and about 0.5 μm. A layer that is too thin can result in poor embossed image quality. A layer that is too thick is inefficient.

The coating is most preferably formed from a material selected from the group selected from a non-crosslinked polystyrene-acrylic emulsion and a non-crosslinked polyester dispersion. The coating preferably has a thickness of about 0.1 μm to about 0.4 μm. Also, the coating may contain a fluorosurfactant.

The non-oriented PET film is preferably stretched in the transverse direction after the coating that forms the embossable layer is applied. Preferably, the PET film is stretched in an amount of about 3.4 to about 5.4 times in the transverse direction. The transverse stretching causes the coating that forms the embossable layer to impregnate surface portions of the PET film.

A transparent HRI coating is applied on top of the embossable layer. In order to achieve sufficient reflectivity, the difference in refractive index between the embossed material and the HRI coating is preferably at least 0.3, more preferably more than 0.6.

Application of the transparent HRI material layer is preferably performed using a vacuum deposition process. Other conventional deposition techniques include reactive or non-reactive vacuum vapor deposition, physical vapor deposition (PVD), chemical vapor deposition (CVD), sputtering, electron beam deposition, ion beam assisted deposition and the like. Preferable transparent HRI materials include ZnS, Sb₂S₃, Fe₂O₃, PbO, ZnSe, CdS, TiO₂, PbCl₂, CeO₂, Ta₂O₅, ZnO, CdO and Nd₂O₃.

The thickness of the transparent HRI coating is preferably thick enough to provide good refractive properties (refract light) but not so thick as to inhibit its transparent properties. Preferably the transparent HRI coating has a thickness of about 50 Angstroms to about 1500 Angstroms. More preferably this coating has a thickness of about 50 Angstroms to about 1000 Angstroms, most preferably about 100 Angstroms to about 800 Angstroms.

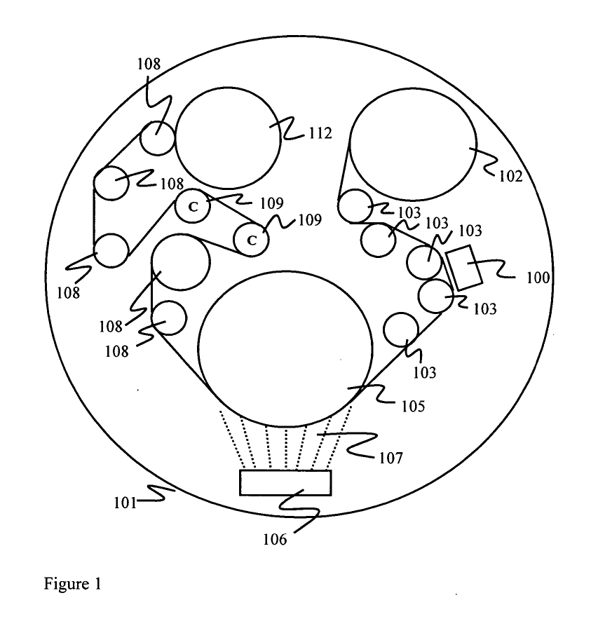

FIG. 1 shows an apparatus for preparing a transparent HRI coating film from a film substrate containing an embossable layer. A vacuum chamber 101 containing a web transport system and an evaporator 106 containing a transparent HRI material is reduced to a predetermined pressure by a vacuum pump. An embossable multi-layer film 102 is unwound and transported through the chamber by an arrangement of driven and idling rollers 103. The embossable multi-layer film 102 is passed over a chilled coating drum 105 and then through a cloud of evaporated transparent HRI material 107 generated by an evaporator 106. The cool surface of the dielectric film causes the HRI material to condense on the surface of the embossable multilayer film 102 forming a thin layer of HRI material. The film is then passed over another arrangement of driven and idling rollers 108 and then rewound at position 112.

Although not required, when an embossable multi-layer film with high surface functionality is used, preferably a surface treatment is applied at position 100. The surface treatment activates a side of the embossable multi-layer film for the deposition of the transparent HRI layer. Exposing the surface of the embossable multi-layer film to an ionized gas, i.e. plasma, or a corona discharge is a preferable surface treatment.

The HRI evaporator 106 can be of any kind of evaporator capable of creating a vapor cloud that is sufficient to condense the HRI material on the surface of the embossable multi-layer film at an appropriate speed. Examples of appropriate evaporators include resistively heated evaporators, electron beam evaporators and sputter sources.

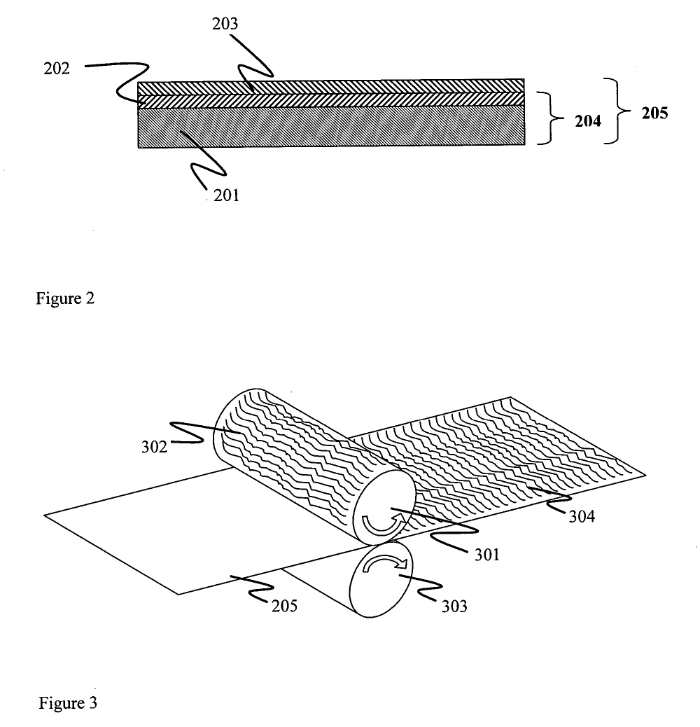

FIG. 2 shows a transparent HRI coated film 205 according to an embodiment of this invention. The embossable base material 204 is comprised of two layers 201 and 202. Layer 201 is a base substrate film. Layer 202 is the inline coated directly embossable layer, that is pliable under heat and can be embossed. Layer 203 is a transparent HRI coating applied according to the method described herein.

The HRI coated film is slit to a width that can be accommodated by common embossing equipment.

Embossing is performed by pressing a shim with the desired grating embedded in its surface onto the embossable substrate, with the HRI coating and the low crystalline skin layer facing the embossing shim. For the embossing process the film can either be preheated to allow the low crystalline polymer to be pliable under the embossing shim, or the shim itself is heated and transfers the heat into the embossable layer making it pliable.

FIG. 3 schematically depicts a continuous embossing process. The embossing shim carrying the diffractive grating 302 is wrapped around the embossing drum 301, that is heated to the embossing temperature. A contact roller 303 is pressing against the embossing roller to build the contact force that is required to create the embossing. The film substrate 205 passes between the embossing drum 301 and the contact roller 303, with the embossable surface layers 202/203 facing the embossing drum 301 and its embossing surface 302. The heat of the embossing drum 301 and the pressure between embossing drum 301 and contact roller 303 imposes the surface structure of the embossing shim 302 into the film surface 304.

The invention is further illustrated by the following examples, which are intended to be exemplary and not limiting.

### EXAMPLE

A biaxially oriented polyethyleneterephthalate film, type Lumirror U6E, produced by Toray Plastics (America), Inc., was produced according to U.S. patent application Ser. Nos. 10/087,689 and 10/206,453. The U6E film was vacuum coated on the embossable coating with a layer of Zinc-Sulfide (ZnS) using a vacuum coating system with a resistive evaporation source. The thickness of the ZnS layer was about 650 Angstroms.

Subsequently the coated film was slit and embossed using an embosser with a heated shim, the shim having a surface grating that is known in the art as “Rainbow Wave Pattern”. Control samples of U6E without the ZnS coating were also embossed as well. The results are listed in Table 1.

### COMPARATIVE EXAMPLE

A biaxially oriented polyethleneterephthalate film, type Lumirror F-65, produced by Toray Plastics (America), Inc., was off-line coated with an embossable coating as is commonly used in the holographic industry. This film was coated with an HRI coating using the above described processes. The thickness of the ZnS layer was about 650 Angstroms.

Subsequently the coated film was slit and embossed using an embosser with a heated shim, the shim having a surface grating that is known in the art as “Rainbow Wave Pattern”. Control samples of F-65 without the ZnS coating were also embossed as well. The results are listed in Table 1.

TABLE 1

| | Embossing Temperatures | | | | |
|---|---|---|---|---|---|
| Sample | | | | | |
| Description | 104° C. | 115° C. | 127° C. | 138° C. | 149° C. |
| U6E w/HRI | None | Poor | Good | Excellent | — |
| U6E w/o HRI | Poor | Good | Excellent | Excellent | |
| F-65 Embossable | None | None | Poor | Poor | Good |
| w/HRI | | | | | |
| F-65 Embossable | Poor | Poor | Good | Excellent | Excellent |
| w/o HRI | | | | | |

Qualitatively, the embossing of the PET film was rated as follows:
Excellent = Bright colors viewed from many angles
Good = Colors not as robust viewed at from different angles
Poor = Colors dull or incomplete embossing noted
None = No embossing visible

The results listed in Table 1 show that polyethyleneterephtalate film with a directly embossable coating applied according to the invention can be embossed with a HRI coating present. It was possible to achieve excellent embossing results with this structure, comparable to the substrate with the commonly used off-line coated embossable coating without HRI coating. It appears that higher temperatures are required to achieve embossing into such off-line coated embossable coatings when a HRI coating is present.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses numerical range limitations. Persons skilled in the art will recognize that the numerical ranges disclosed inherently support any range within the disclosed numerical ranges even though a precise range limitation is not stated verbatim in the specification because this invention can be practiced throughout the disclosed numerical ranges and at other numerical ranges which persons skilled in the art will find this invention operable.

We claim:

1. An embossable film comprising:
a base layer;
an embossable layer on a surface of the base layer; and
a high reflective index layer on a surface of the embossable layer, wherein the embossable film is directly embossable.

2. The embossable film of claim 1, wherein the base layer comprises polyethyleneterephthalate.

3. The embossable film of claim 1, wherein the embossable layer comprises a non-crosslinked polystyrene-acrylic or a non-crosslinked polyester.

4. The embossable layer of claim 1, wherein the embossable layer comprises a resin having a Tg of greater than 20° C. and less than 70° C.

5. The embossable film of claim 1, wherein the base layer has a thickness of 4.5 μm to 150 μm.

6. The embossable film of claim 1, wherein the embossable layer has a thickness of 0.1 μm to 2.0 μm.

7. The embossable film of claim 1, wherein the transparent high reflective index layer comprises ZnS, Sb₂S₃, Fe₂O₃, PbO, ZnSe, CdS, TiO₂, PbCl₂, CeO₂, Ta₂O₅, ZnO, CdO or Nd₂O₃.

8. The embossable film of claim 1, wherein the transparent high reflective index layer has a thickness of 50 Angstroms to 1500 Angstroms.

9. The embossable film of claim 1, wherein the transparent high reflective index layer is applied using a physical vapor deposition process.

10. A method of producing a diffraction grating comprising:
providing a substrate film with an embossable layer;
applying a transparent high reflective index layer on top of the embossable layer; and
embossing the film to create a diffraction grating.

11. The method of claim 10, wherein the base layer comprises polyethyleneterephtalate.

12. The method of claim 10, wherein the embossable layer comprises a non-crosslinked polystyrene-acrylic or a non-crosslinked polyester.

13. The method of claim 10, wherein the embossable layer comprises a resin having a Tg of greater than 20° C. and less than 70° C.

14. The method of claim 10, wherein the base layer has a thickness of 4.5 μm to 150 μm.

15. The method of claim 10, wherein the embossable layer has a thickness of 0.1 μm to 2.0 μm.

16. The method of claim 10, wherein the transparent high reflective index layer comprises ZnS, Sb₂S₃, Fe₂O₃, PbO, ZnSe, CdS, TiO₂, PbCl₂, CeO₂, Ta₂O₅, ZnO, CdO or Nd₂O₃.

17. The method of claim 10, wherein the transparent high reflective index layer has a thickness of 50 Angstroms to 1500 Angstroms.

18. The method of claim 10, wherein the transparent high reflective index layer is applied using a physical vapor deposition process.

19. A method of producing a directly embossable film comprising:
providing a polyethyleneterephthalate film;
stretching the polyethyleneterephthalate film to form a uniaxially oriented polyethyleneterephthalate film;
coating at least one surface of the uniaxially oriented polyethyleneterephthalate film with an aqueous solution of an organic material to form an embossable layer;
transverse stretching the coated uniaxially oriented polyethyleneterephthalate film; and
applying a transparent high reflective index coating to embossable layer of the polyethyleneterephthalate film to form a directly embossable film.

20. The method of claim 19, wherein the aqueous solution comprises a non-crosslinked polystyrene-acrylic or a non-crosslinked polyester.

21. The method of claim 19, wherein the aqueous solution comprises a resin having a Tg of greater than 20° C. and less than 70° C.

22. The method of claim 19, wherein the base layer has a thickness of 4.5 μm to 150 μm.

24. The method of claim 19, wherein the embossable layer has a thickness of 0.1 μm to 2.0 μm.

25. The method of claim 19, wherein the transparent high reflective index layer comprises ZnS, Sb₂S₃, Fe₂O₃, PbO, ZnSe, CdS, TiO₂, PbCl₂, CeO₂, Ta₂O₅, ZnO, CdO or Nd₂O₃.

26. The method of claim 19, wherein the transparent high reflective index layer has a thickness of 50 Angstroms to 1500 Angstroms.

27. The method of claim 19, wherein the transparent high reflective index layer is applied using a physical vapor deposition process.
